(19) United States
(12) Patent Application Publication
(10) Pub. No.: US 2025/0272807 A1
(43) Pub. Date: Aug. 28, 2025

(54) MASK-FREE COMPOSITE IMAGE GENERATION

(71) Applicant: ADOBE INC., SAN JOSE, CA (US)

(72) Inventors: Gemma Canet Tarrés, Guildford (GB); Soo Ye Kim, San Jose, CA (US); Zhe Lin, Clyde Hill, WA (US); Zhifei Zhang, San Jose, CA (US); Jianming Zhang, Cupertino, CA (US); Yizhi Song, West Lafayette, IN (US)

(21) Appl. No.: 18/584,022

(22) Filed: Feb. 22, 2024

(51) Int. Cl. G06T 5/77; G06T 5/50; G06T 5/75; G06T 7/149

(52) U.S. Cl. CPC G06T 5/77; G06T 5/50; G06T 5/75; G06T 7/149; G06T 2207/20081

(57) ABSTRACT

A method, apparatus, non-transitory computer readable medium, and system include obtaining a first image depicting a background scene and a second image depicting a foreground element, generating a guidance embedding based on the second image, and generating a synthetic image depicting the foreground element and the background scene based on the first image and the guidance embedding, wherein the image generation model determines a location of the foreground element within the synthetic image in light of the background scene.

### BACKGROUND

The following relates generally to image processing, and more specifically to image compositing using a machine learning model. Image processing refers to the use of a computer to edit an image using an algorithm or a processing network. In some cases, image processing software can be used for various image processing tasks, such as image editing, image restoration, image detection, image generation, and image compositing. For example, image compositing may include inserting an image depicting an object into an image depicting a background scene to obtain a combined image.

### SUMMARY

Aspects of the present disclosure provide methods, non-transitory computer readable media, apparatuses, and systems for image processing. According to an aspect of the present disclosure, an image generation model is trained to generate a composite image based on a foreground image depicting a foreground object and a background image depicting a background scene. Aspects of the present disclosure further include an adaptor network that generates a guidance embedding based on the foreground image. In one aspect, the image generation model further receives a noise map as input. The image generation model generates the synthetic image based on the guidance embedding, the background image, and the noise map.

According to some embodiments, the noise map has the same resolution as the background image. By applying the noise map to all pixels of the background image, the image generation model can generate a composite image that depicts a foreground element in any region of the background scene. In some embodiments, one or more foreground images depicting multiple foreground objects are used to generate the composite image. The image generation model can automatically composite foreground objects from the one or more foreground images into one or more regions of the background scene of the composite image. In one aspect, the location of the foreground objects in the background scene of the composite image is dynamically determined by the machine learning model.

According to some aspects, the guidance embedding encodes contents of the foreground image (or foreground element) in an embedding more compatible as an input to the image generation model. In some cases, the guidance embedding provides more information to the image generation model about the foreground image than the information provided by a text embedding of a text description of the foreground image. Accordingly, by generating the composite image based on the guidance embedding from the foreground image, the composite image includes a more realistic and natural composition than an image generated by a conventional image generation model.

A method, apparatus, non-transitory computer readable medium, and system for image processing include obtaining a first image depicting a background scene and a second image depicting a foreground element, generating, using an adapter network, a guidance embedding based on the second image, and generating, using an image generation model, a synthetic image depicting the foreground element and the background scene based on the first image and the guidance embedding, wherein the image generation model determines a location of the foreground element within the synthetic image in light of the background scene.

A method, apparatus, non-transitory computer readable medium, and system for image processing include obtaining training data including a training foreground image, a training background image, and a ground truth image that combines the training foreground image and the training background image, and training, using the training data, an image generation model to generate a synthetic image based on an input foreground image and an input background image, wherein the synthetic image includes a foreground element from the input foreground image and a background region from the input background image.

An apparatus, system, and method for image processing include at least one processor, at least one memory storing instructions executable by the at least one processor, an image encoder comprising parameters stored in the at least one memory and trained to encode a foreground image to obtain an image embedding, an adapter network comprising parameters stored in the at least one memory and trained to generate a guidance embedding based on the image embedding, and an image generation model comprising parameters stored in the at least one memory and trained to generate a synthetic image based on a background image and the guidance embedding, wherein the synthetic image depicts a foreground element and a first portion of the background scene, and wherein the foreground element is located at a position of the synthetic image that is determined by the image generation model.

### BRIEF DESCRIPTION OF THE DRAWINGS

FIG. 1 shows an example of an image processing system according to aspects of the present disclosure.

FIG. 2 shows an example of a method for generating a synthetic image based on a foreground image and a background image according to aspects of the present disclosure.

FIG. 3 shows an example of an image generation of a synthetic image according to aspects of the present disclosure.

FIG. 4 shows an example of an image generation using location information according to aspects of the present disclosure.

FIG. 5 shows an example of an image generation with a predicted object mask according to aspects of the present disclosure.

FIG. 6 shows an example of a method for generating a synthetic image according to aspects of the present disclosure.

FIG. 7 shows an example of an image processing apparatus according to aspects of the present disclosure.

FIG. 8 shows an example of data flow in an image processing apparatus according to aspects of the present disclosure.

FIG. 9 shows an example of a diffusion model according to aspects of the present disclosure.

FIG. 10 shows an example of a method for image processing according to aspects of the present disclosure.

FIG. 11 shows an example of generating training data according to aspects of the present disclosure.

FIG. 12 shows an example of generating a training foreground image and a training background image according to aspects of the present disclosure.

FIG. 13 shows an example of training an adapter network according to aspects of the present disclosure.

FIG. 14 shows an example of a method for training an adapter network according to aspects of the present disclosure.

FIG. 15 shows an example of a computing device according to aspects of the present disclosure.

### DETAILED DESCRIPTION

Aspects of the present disclosure provide methods, non-transitory computer readable media, apparatuses, and systems for image processing. According to some aspects, an image generation model is trained to generate a composite image based on a foreground image depicting a foreground object and a background image depicting a background scene. Aspects of the present disclosure further include an adaptor network that generates a guidance embedding based on the foreground image. In one aspect, the image generation model further receives a noise map as input. The image generation model generates the synthetic image based on the guidance embedding, the background image, and the noise map.

By applying the noise map to all pixels of the background image, the image generation model can generate a composite image that depicts a foreground element in any region of the background scene. In some embodiments, one or more foreground images depicting multiple foreground objects are used to generate the composite image. The image generation model can automatically composite foreground objects from the one or more foreground images into one or more regions of the background scene of the composite image. In one aspect, the location of the foreground objects in the background scene of the composite image is determined by the machine learning model.

According to some aspects, the guidance embedding encodes contents of the foreground image (or foreground element) in an embedding more compatible as an input to the image generation model. In some cases, the guidance embedding provides more information to the image generation model about the foreground image than the information provided by a text embedding of a text description of the foreground image. Accordingly, by generating the composite image based on the guidance embedding from the foreground image, the composite image includes a more realistic and natural composition than an image generated by a conventional image generation model.

According to some aspects, the machine learning model generates a plurality of images based on the foreground image. For example, each of the plurality of images depicts a scaled foreground element from the foreground image. In some cases, the adapter network generates a plurality of guidance embeddings based on the plurality of images. The machine learning model takes an average of the plurality of guidance embeddings and provide the averaged guidance embedding into the image generation model. By averaging the plurality of guidance embeddings, the image generation model can receive the foreground element with varying scales. Accordingly, the image generation model can accurately determine the scale of the foreground object within the synthetic image.

A subfield in image compositing relates to combining elements from multiple images to create a combined image. In some cases, the combined image (also referred to as a synthetic image) is seamlessly integrated. For example, elements in the combined image are modified, adjusted, or resized, so that the overall appearance of the combined image is natural and cohesive. However, conventional image compositing techniques are constrained by, for example, bounding boxes and masks indicating the location of the foreground elements in a background scene.

In some cases, image compositing techniques require a user to provide location information of each foreground element to be combined. For example, location information may include a mask or a bounding box defining the location and scale of the foreground element to be placed in the background image. In some cases, multiple foreground images are used to combine with a background image. As a result, defining a bounding box for each foreground image is time-consuming.

In some cases, for example, a conventional image generation model generates a synthetic image by compositing a foreground element from the foreground image to the background scene of the background image. The foreground element, however, is confined within the size and location of the bounding box. In some cases, additional features, such as shadows and reflections, are added within the region of the background image specified by the bounding box. As a result, the overall appearance of the synthetic image might not be natural and cohesive due to the constraint of the bounding box.

Accordingly, the present disclosure provides systems and methods that improve on conventional image generation models by generating composite images more efficiently and accurately. For example, embodiments of the disclosure are capable of accurately depicting natural relationships such as shadows and reflections, as well as diverse compositions of a foreground object and a background scene. To achieve the improved accuracy, embodiments of the disclosure include an image generation model trained using training data that includes a ground truth composite image, a synthetic foreground image, and a synthetic background image. By using this training data, the image generation model can learn natural relationships between the foreground object and the background scene. By generating the foreground object at any region of the background scene of the composite image, the image generation model can generate corresponding object effects, such as shadows and reflections, at the corresponding region, making the composite image more diverse and realistic.

According to some aspects, the image generation model receives an averaged guidance embedding based on a plurality of scaled foreground images to generate the synthetic image. By averaging the plurality of guidance embeddings, the image generation model can receive the foreground element with varying scales. Accordingly, the image generation model can accurately determine the scale of the foreground object within the synthetic image. As a result, the image composition of the synthetic image is semantically realistic.

According to some aspects, the image generation model of the present disclosure receives location information as an optional input. The generated foreground element is located in a region of the synthetic image specified by the location information. However, the location information does not constrain the size, orientation, and configuration of the foreground element. For example, the location information is used as a guidance input to the image generation model. The image generation model performs a reverse diffusion process on all pixels of the background image to generate the synthetic image. As a result, guided by the location information, the image generation model generates a synthetic image having a foreground element located (but not constrained) in the background scene as indicated by the location information. In some cases, the overall appearance of the synthetic image is cohesive and natural.

According to some aspects, the image generation model of the present disclosure generates a synthetic image and a corresponding object mask (e.g., foreground element mask) as an output. For example, the object mask depicts information, such as location, size, shape, and orientation, of the foreground element in the synthetic image. In some cases, the object mask is different than the object depicted in the foreground image. In some cases, the object mask can be used to further edit the synthetic image.

According to some aspects, the image generation model is trained using training data that includes a ground truth image, a training foreground image, and a training background image. In some embodiments, a segmentation component is used to generate a segmentation mask based on the ground truth image. In some cases, the training foreground image is generated using the segmentation mask. In some embodiments, an inpainting component is used to generate an inpainting mask based on the segmentation mask. In some cases, the inpainting component generates the training background image based on the inpainting mask by performing inpainting. In some cases, the inpainting component refines the training background image to depict additional elements that might not be in the ground truth image.

By training the image generation model with the training data, embodiments of the present disclosure can enhance image processing applications or image compositing applications such as film and video production, digital art collage, digital photography, and content creation by efficiently generating synthetic images with multiple input images. For example, the image generation model can generate a synthetic image that is natural and cohesive without a user input of a mask or bounding box to limit the foreground object in the synthetic image. In some embodiments, location information is provided by the user to guide the image generation model, where the rough location of the foreground element in the synthetic image is determined based on the location information. Additionally or alternatively, the data preparation process described by the present disclosure can be used to complement (e.g., increase the performance of) an existing image generation model. For example, by training the image generation model using the training data (described by the data preparation process), embodiments of the present disclosure can increase model capacity and reduce processing time in image compositing.

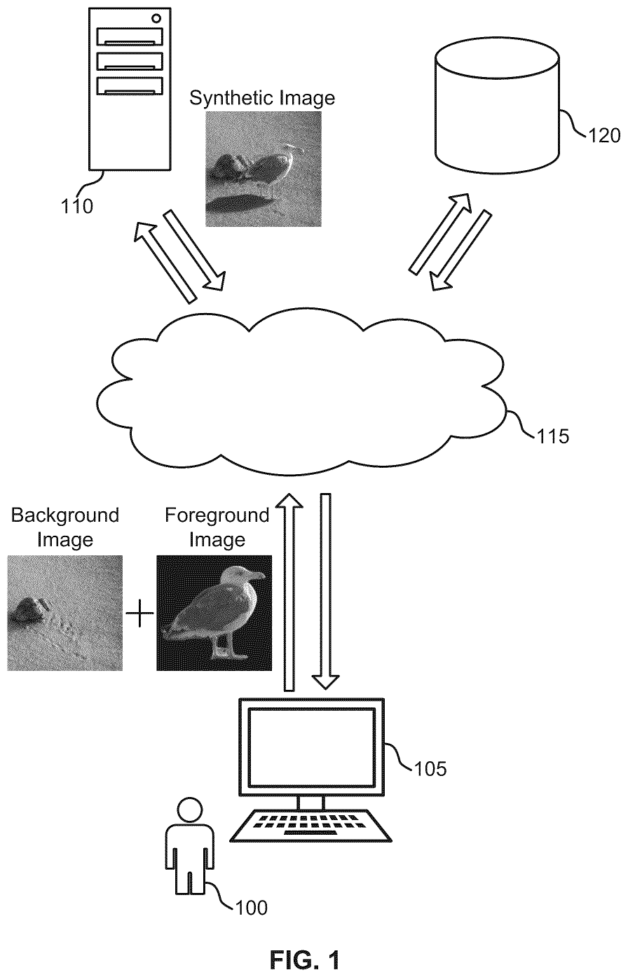

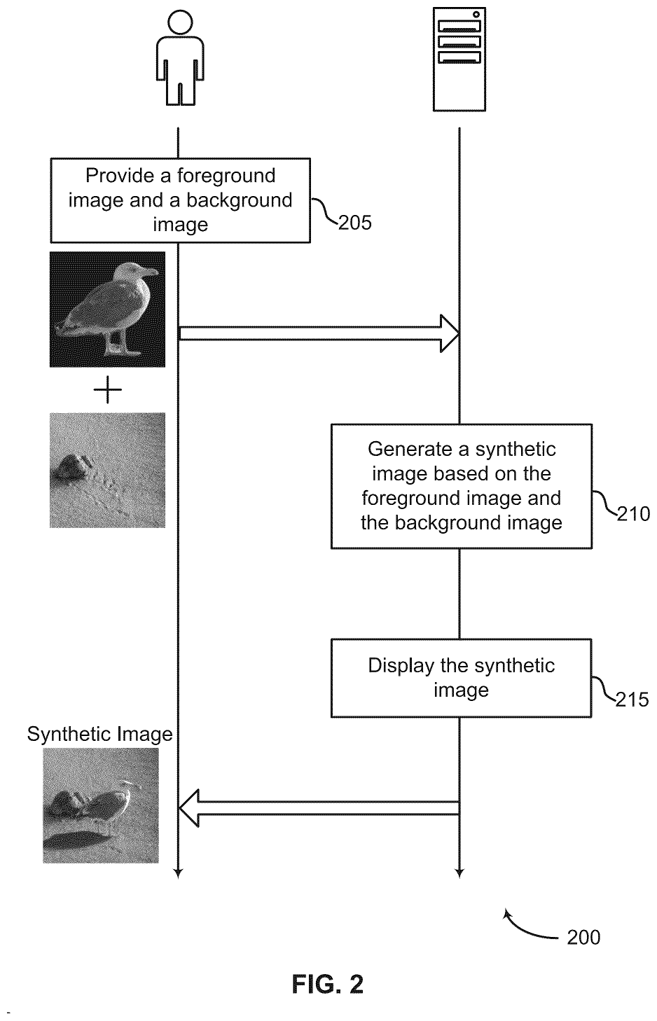

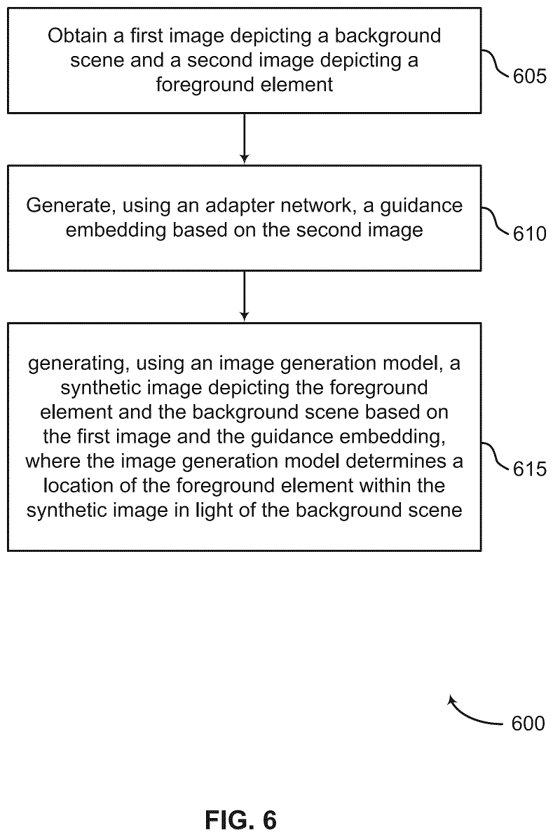

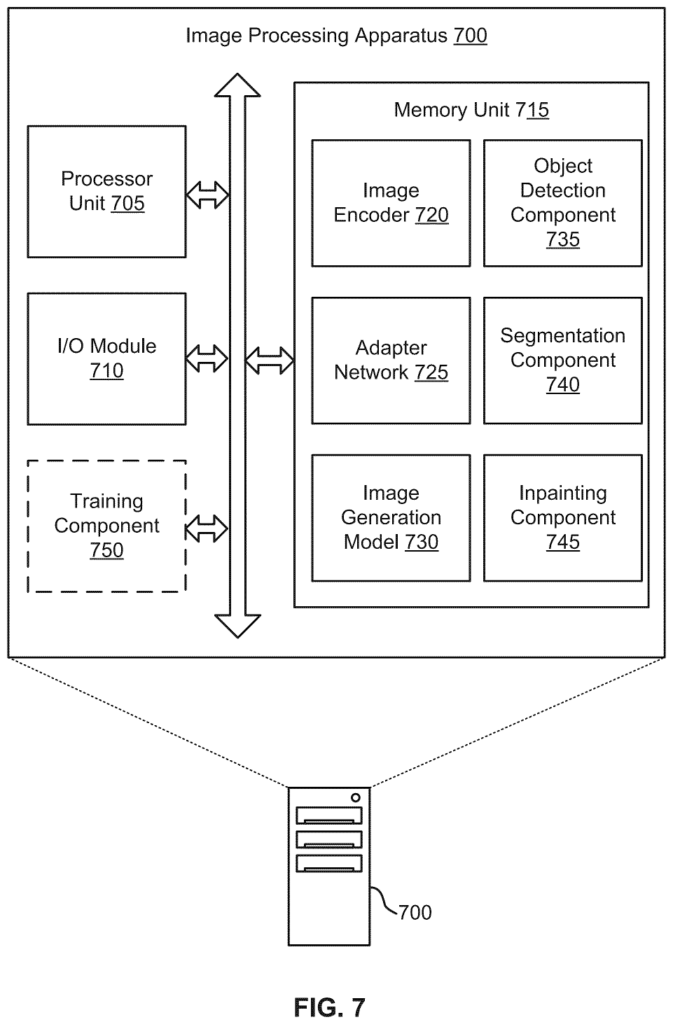

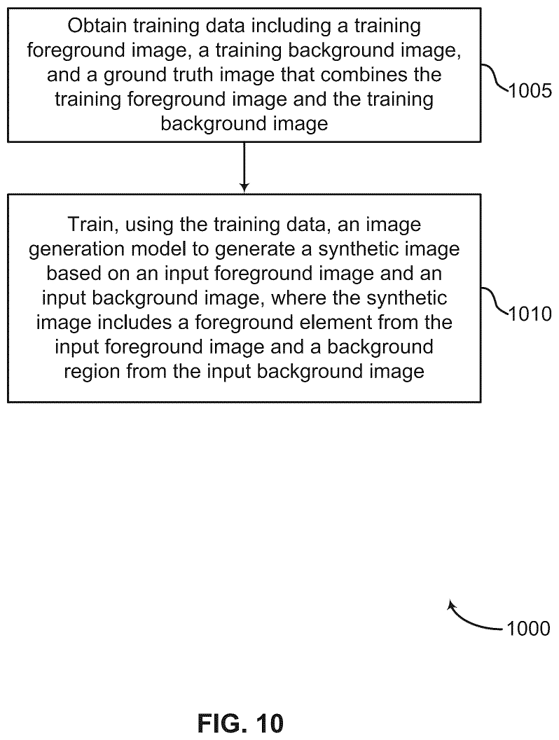

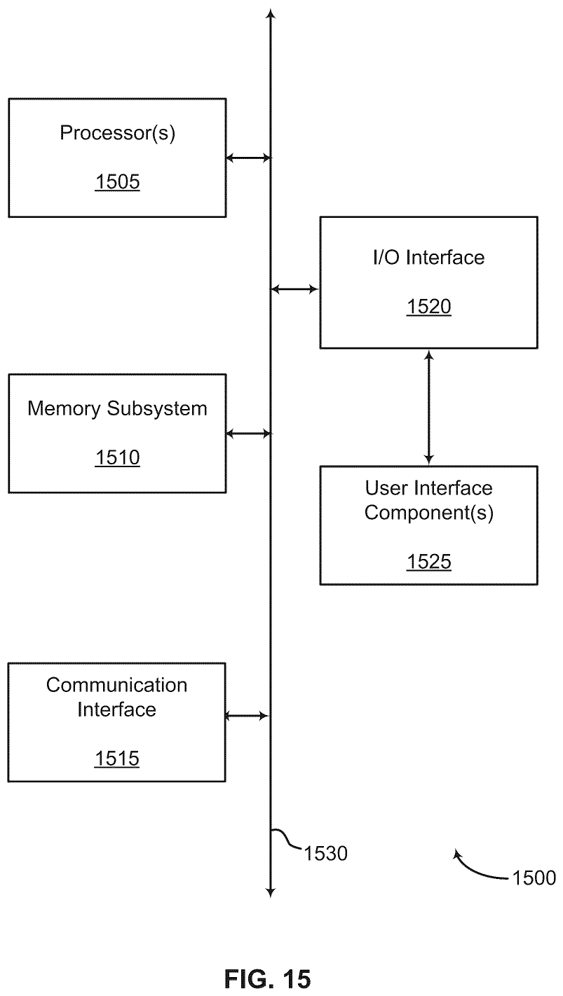

An example system of the inventive concept in image processing is provided with reference to FIGS. 1 and 15. An example application of the inventive concept in image processing is provided with reference to FIGS. 2-5. Details regarding the architecture of an image processing apparatus are provided with reference to FIGS. 7-9. An example of a process for image processing is provided with reference to FIG. 6. A description of an example training process is provided with reference to FIGS. 10-14.

### Image Processing

In FIGS. 1-6, a method, apparatus, non-transitory computer readable medium, and system for image processing are described. One or more aspects of the method, apparatus, non-transitory computer readable medium, and system include obtaining a first image depicting a background scene and a second image depicting a foreground element. Embodiments further include generating, using an adapter network, a guidance embedding based on the second image. Embodiments further include generating, using an image generation model, a synthetic image based on the first image and the guidance embedding. In some cases, the synthetic image depicts the foreground element from the second image and at least a portion of the background scene.

Some examples of the method, apparatus, non-transitory computer readable medium, and system further include obtaining a first image depicting a background scene and a second image depicting a foreground element, generating, using an adapter network, a guidance embedding based on the second image, and generating, using an image generation model, a synthetic image depicting the foreground element and the background scene based on the first image and the guidance embedding, wherein the image generation model determines a location of the foreground element within the synthetic image in light of the background scene.

Some examples of the method, apparatus, non-transitory computer readable medium, and system further include encoding, using an image encoder, the second image to obtain an image embedding, wherein the guidance embedding is generated based on the image embedding.

Some examples of the method, apparatus, non-transitory computer readable medium, and system further include combining the first image with a noise map to obtain a noisy image, wherein the image generation model takes the noisy image as input. In some aspects, the noise map has a same resolution as the first image. Some examples of the method, apparatus, non-transitory computer readable medium, and system further include performing a reverse diffusion process.

Some examples of the method, apparatus, non-transitory computer readable medium, and system further include obtaining location information for the foreground element of the second image, wherein a location of the foreground element in the synthetic image is determined based on the location information. In some aspects, a size of the foreground element is determined by the location information.

Some examples of the method, apparatus, non-transitory computer readable medium, and system further include obtaining an additional image depicting an additional foreground element, wherein the synthetic image is generated to depict the additional foreground element. In some aspects, the image generation model is trained to combine multiple images using training data that includes a foreground image, a background image, and a ground truth image that combines the foreground image and the background image.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIGS. 7, 8, and 13.

Referring to FIG. 1, user 100 provides a background image depicting a background scene and a foreground image depicting a foreground element to image processing apparatus 110 via user device 105 and cloud 115. In some cases, multiple foreground images are provided to image processing apparatus 110. The background image, for example, depicts a background scene of sand on a beach. The foreground image, for example, depicts a seagull. In some cases, for example, the synthetic image depicts a seagull (e.g., a foreground element) on the beach (e.g., a background scene). In some cases, the background image and foreground image are provided by database 120. In some cases, the background image and foreground image are provided by user 100.

In some cases, image processing apparatus 110 uses a machine learning model to generate the synthetic image based on the background image and a guidance embedding of the foreground image. In some cases, the foreground element is naturally positioned (including size, orientation, shape, and location) in the background scene. The foreground element is not restrained within a region of the background scene. In some cases, the image generation model generates additional elements, such as shadows and reflections of the foreground element in the synthetic image.

In some cases, image processing apparatus 110 uses a machine learning model to generate a synthetic image based on the background image and a guidance embedding of the foreground image. The machine learning model uses the guidance embedding to preserve the characteristics of the foreground element in the synthetic image while modifying other features such as shape, size, orientation, shadow, lighting, reflection, etc. Accordingly, the foreground element and background scene are composited in a visually harmonious and realistic manner. In some cases, image processing apparatus 110 displays the synthetic image to user 100 via user device 105 and cloud 115.

As used herein, the term “background scene” refers to a region or elements of the background image that appears behind a main object. As used herein, the term “foreground element” refers to an element, an object, or a portion of an object that is intended to be depicted in a synthetic image in front of the background scene. As used herein, the term “synthetic image” refers to an image generation by an image generation model that combines elements from two or more images.

As used herein, the term “embedding” refers to a numerical representation of words, sentences, documents, or images in a vector space. The embedding is used to encode semantic meaning, relationships, and context of the words, sentences, documents, or images where the encoding can be processed by a machine learning model.

In some cases, an embedding can be produced in a “modality” (such as a text modality, an image modality, an audio modality, etc.) that corresponds to a modality of the corresponding object. In some cases, embeddings in different modalities include different dimensions and characteristics, and making a direct comparison of embeddings from different modalities is difficult. In some cases, an embedding for an object can be generated or translated into a multi-modal embedding space, such that objects from multiple modalities can be effectively compared with each other.

As used herein, a “guidance embedding” refers to a translation of an image embedding into a text embedding or multi-modal embedding, such that the guidance embedding includes information from the image modality with one or more characteristics associated with the text embedding or multi-modal embedding. In some cases, a guidance embedding can effectively substitute a text embedding as guidance for a reverse diffusion process of the image generation model.

User device 105 may be a personal computer, laptop computer, mainframe computer, palmtop computer, personal assistant, mobile device, or any other suitable processing apparatus. In some examples, user device 105 includes software that incorporates an image detection application. In some examples, the image detection application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIGS. 7, 8, and 13. According to some aspects, image processing apparatus 110 includes a computer implemented network comprising a machine learning model, an image encoder, an adapter network, an image generation model, an object detection component, a segmentation component, and an inpainting component. Image processing apparatus 110 further includes a processor unit, a memory unit, an I/O module, and a training component. In some embodiments, image processing apparatus 110 further includes a communication interface, user interface components, and a bus as described with reference to FIG. 15. Additionally, image processing apparatus 110 communicates with user device 105 and database 125 via cloud 115. Further detail regarding the operation of image processing apparatus 110 is provided with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data including a ground truth image, a training foreground image, and a training background image. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for generating a synthetic image based on a foreground image and a background image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

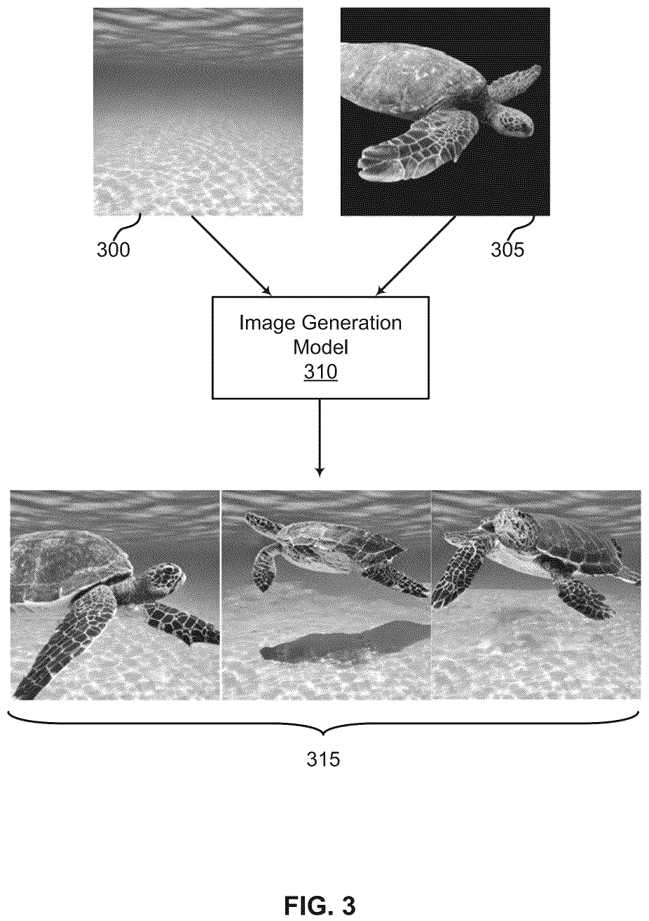

Referring to FIG. 2, for example, a foreground image depicting a seagull and a background image depicting a beach are provided to the image processing apparatus (e.g., the image processing apparatus described with reference to FIG. 1). In some cases, multiple foreground images are provided to the image processing apparatus. The image processing apparatus generates a synthetic image depicting the seagull on the beach and displays the synthetic image to the user. In some cases, additional features such as reflections and shadows are added to the synthetic image so that the overall appearance is harmonious and realistic. In some cases, the image processing apparatus displays multiple synthetic images, where each of the synthetic images has a different image composition of the seagull and beach. Further details on and examples of the synthetic image are described with reference to FIGS. 3-5 and 8.

At operation 205, the system provides a foreground image and a background image. In some cases, the operations of this step refer to, or may be performed by, a user as described with reference to FIG. 1. In some cases, for example, the user provides a foreground image depicting a foreground element of a seagull and a background image depicting a background scene of a beach to image processing apparatus via a user interface provided by the image processing apparatus on a user device (e.g., the user device described with reference to FIG. 1). In some cases, the user may provide multiple foreground images depicting different foreground objects to the image processing apparatus. For example, the user may provide multiple images depicting a seal, fisherman, boat, etc.

At operation 210, the system generates a synthetic image based on the foreground image and the background image. In some cases, the operations of this step refer to, or may be performed by, an image processing apparatus as described with reference to FIGS. 1, 7, 8, and 13. In some cases, the operations of this step refer to, or may be performed by, an image generation model as described with reference to FIGS. 3-5, 7, and 8. In some cases, for example, the image processing apparatus generates, using an adapter network, a guidance embedding based on the foreground image. The guidance embedding encodes contents of the foreground image (or foreground element) in an embedding more compatible as an input to an image generation model of the image processing apparatus. In some cases, a noise map is added to the background image to obtain a noisy image, where noise is applied to all pixels of the background image. The image generation model generates the synthetic image based on the noisy map and the guidance embedding.

At operation 215, the system displays the synthetic image. In some cases, the operations of this step refer to, or may be performed by, an image processing apparatus as described with reference to FIGS. 1, 7, 8, and 13. In some cases, the synthetic image is displayed on a user device via a user interface of the image processing apparatus and cloud.

FIG. 3 shows an example of an image generation of a synthetic image according to aspects of the present disclosure. The example shown includes background image 300, foreground image 305, image generation model 310, and synthetic image 315.

Referring to FIG. 3, image generation model 310 receives background image 300 and foreground image 305 and generates synthetic image 315. In some cases, synthetic image 315 includes one or more images. In some cases, background image 300 and foreground image 305 are provided by a user. For example, background image 300 depicts a background scene of an underwater environment. For example, foreground image 305 depicts a sea turtle. synthetic image 315 on the left depicts a sea turtle underwater. For example, the view of the sea turtle in the synthetic image 315 on the left is different from the view of the sea turtle in the foreground image 305. In some cases, image generation model 310 receives a guidance embedding based on foreground image 305, where the identity or feature of the sea turtle is preserved. In some cases, the size, orientation, and location of the sea turtle in synthetic image 315 are adjusted. For example, synthetic image 315 in the middle depicts a sea turtle underwater, where the head of the sea turtle is pointed in a direction opposite to the direction depicted in foreground image 305. Additionally, synthetic image 315 includes a shadow below the turtle.

Conventional image generation models are unable to generate an image without an additional input of a bounding box or mask. For example, the bounding box defines the exact position and scale of the foreground object in the generated image. In some cases, defining the bounding box with the required precision can be time-consuming. In some cases, identifying or defining the bounding box might not scale to multi-object compositing. For example, when more than one foreground object is to be combined, a user needs to define each bounding box.

In some cases, image generation is limited to a region of the background scene specified by the bounding box. Additionally, the remaining region of the background scene might not be modified in the generated image. For example, conventional image generation models perform a diffusion process within the bounding box, and the remaining region of the background scene may be the same as the background scene of the synthetic image. As a result, the conventional image generation model cannot generate additional effects (such as shadows, reflections, etc.) to the remaining portions of the generated image. Accordingly, the overall appearance of the generated image may be unnatural and unbalanced.

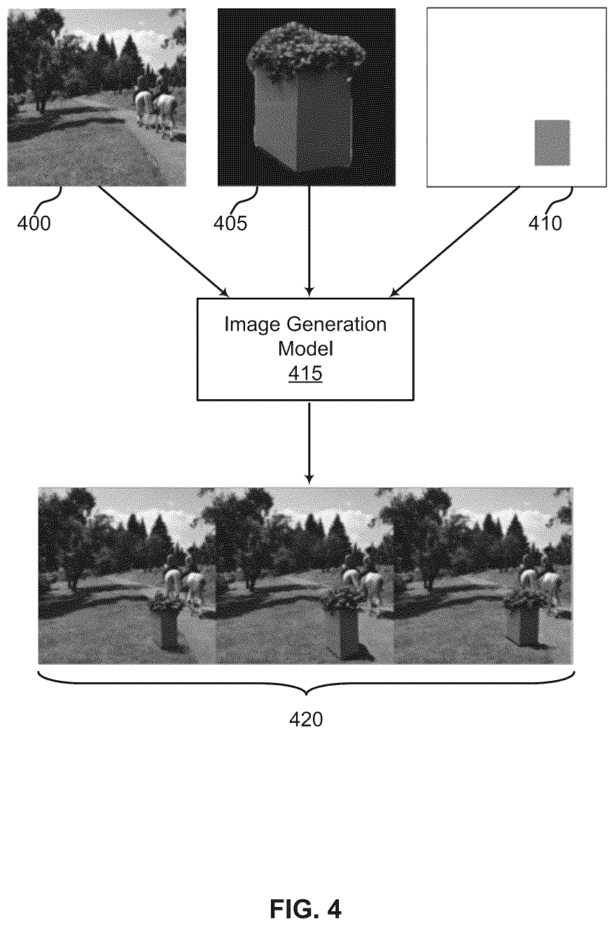

Background image 300 is an example of, or includes aspects of, the corresponding element described with reference to FIGS. 4, 5, and 8. Foreground image 305 is an example of, or includes aspects of, the corresponding element described with reference to FIGS. 4, 5, and 8. Image generation model 310 is an example of, or includes aspects of, the corresponding element described with reference to FIGS. 4, 5, 7, and 8. Synthetic image 315 is an example of, or includes aspects of, the corresponding element described with reference to FIGS. 4, 5, and 8.

FIG. 4 shows an example of an image generation using location information according to aspects of the present disclosure. The example shown includes background image 400, foreground image 405, location information 410, image generation model 415, and synthetic image 420.

Referring to FIG. 4, image generation model 415 receives background image 400 depicting a park, foreground image 405 depicting a pot of plant, and location information 410 to generate synthetic image 420. In some cases, synthetic image 420 includes one or more images. In some cases, background image 400 and foreground image 405 are provided by a user. In some cases, the user selects background image 400 and foreground image 405 from a database provided by the image processing system. In some cases, the user provides an additional input of location information 410 to guide the image generation model 415.

Features of the foreground element in foreground image 405 are guided by location information 410. For example, location information 410 indicates a rough location (including position and scale) of the foreground element in the background scene. In some cases, for example, location information 410 is represented by a bounding box or a mask. As shown in the example, the pot of plant (e.g., the foreground object) is guided to be placed in the bottom right corner of the background scene. Synthetic image 420 includes three variations illustrating the guidance. However, the size of the foreground element is not constrained within location information 410 because image generation model 415 performs a reverse diffusion process on all pixels of the image rather than a region of the image.

Background image 400 is an example of, or includes aspects of, the corresponding element described with reference to FIGS. 3, 5, and 8. Foreground image 405 is an example of, or includes aspects of, the corresponding element described with reference to FIGS. 3, 5, and 8. Image generation model 415 is an example of, or includes aspects of, the corresponding element described with reference to FIGS. 3, 5, 7, and 8. Synthetic image 420 is an example of, or includes aspects of, the corresponding element described with reference to FIGS. 3, 5, and 8.

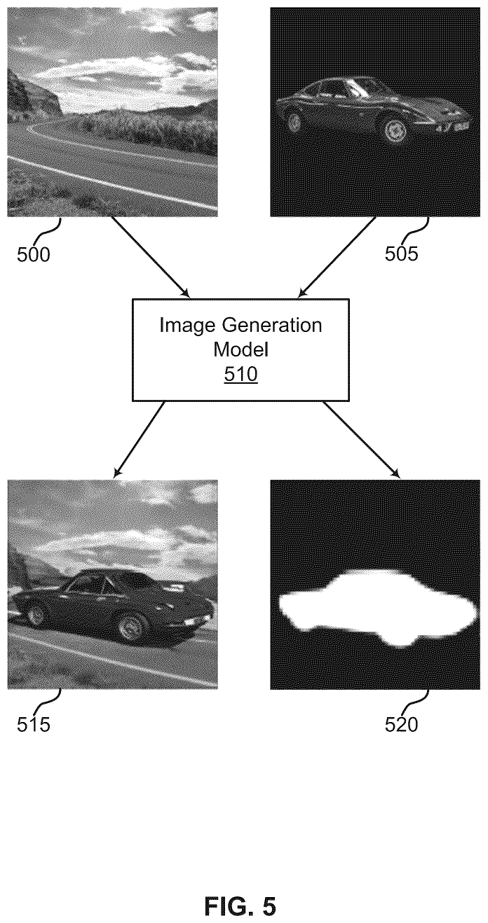

FIG. 5 shows an example of an image generation with a predicted object mask according to aspects of the present disclosure. The example shown includes background image 500, foreground image 505, image generation model 510, synthetic image 515, and object mask 520.

Referring to FIG. 5, image generation model 510 receives background image 500 depicting a road and a foreground image 505 depicting a car to generate synthetic image 515 and an object mask 520. In one aspect, object mask 520 depicts a region of the foreground element in synthetic image 515. In some cases, the object mask 520 is different than the semantic mask of the foreground image 505. In some cases, the object mask 520 is used to generate the foreground element of the synthetic image 515. In some cases, object mask 520 is a binary mask used to locate the foreground object in synthetic image 515 for post-processing. In some cases, for example, post-processing includes applying additional edits on synthetic image 515.

Background image 500 is an example of, or includes aspects of, the corresponding element described with reference to FIGS. 3, 4, and 8. Foreground image 505 is an example of, or includes aspects of, the corresponding element described with reference to FIGS. 3, 4, and 8. Image generation model 510 is an example of, or includes aspects of, the corresponding element described with reference to FIGS. 3, 4, 7, and 8. Synthetic image 515 is an example of, or includes aspects of, the corresponding element described with reference to FIGS. 3, 4, and 8.

FIG. 6 shows an example of a method 600 for generating a synthetic image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, an image processing apparatus (e.g., the image processing apparatus described with reference to FIGS. 1, 2, 7, 8, and 13) generates a synthetic image based on a foreground image depicting a foreground element and a background image depicting a background scene. In some cases, the synthetic image includes the foreground element in a region of the background scene.

In some cases, the image generation model includes a diffusion model guided by a guidance embedding based on the foreground image. A conventional image generation model might generate an image guided by a text description of the foreground element, where the text description could be manually or automatically generated. However, the text description of the foreground object cannot be as fully descriptive of the foreground element as the image of the foreground element. Furthermore, an image embedding of the foreground image is less usable by the image generation model as guidance than a text embedding, which results in an unrealistic or unbalanced image.

Therefore, in some cases, the guidance embedding is generated, by using an adapter network, based on an image embedding of the foreground image such that the guidance embedding retains information of the image embedding but in a text domain more usable by the image generation model. By using the guidance embedding, the image generation model can retain the identity of the foreground element while other features of the background image and/or foreground image are modified. As a result, the overall appearance of a synthetic image is more natural and cohesive.

Additionally, a noise map is combined with a background image to obtain a noisy image, where the noisy image is used as input to the image generation model. By performing a reverse diffusion process on all pixels of the noisy image, the image generation model is able to generate a synthetic image that seamlessly integrates the foreground object to any region of the background scene making the appearance of the synthetic image more natural and balanced. Furthermore, by performing a reverse diffusion process on all pixels of the noisy image, a user input of a bounding box might not be needed.

At operation 605, the system obtains a first image depicting a background scene and a second image depicting a foreground element. In some cases, the operations of this step refer to, or may be performed by, an image generation model as described with reference to FIGS. 3-5, 7, and 8. In some cases, the first image can be referred to as the background image. In some cases, the second image can be referred to as the foreground image. In some cases, the foreground element includes a foreground object to be combined with the background scene.

In some cases, for example, the user provides one or more foreground images and background images to the image generation model. In some cases, the image generation model receives one or more foreground images and the background image from a database (e.g., the database described with reference to FIG. 1) or from another data source (such as the Internet). In some cases, the image generation model receives the one or more foreground images and background image in response to a user instruction (provided, for example, via the graphical user interface).

In some cases, the user can provide optional location information of the foreground image. For example, the location information includes a mask or a bounding box. In some cases, the location information is used to guide the image generation model. In some cases, location information indicates a rough location (including position and scale) of the foreground element in the background scene. However, the size of the foreground element is not constrained within the location information because the image generation model performs a reverse diffusion process on all pixels of the image rather than a region of the image. Further details on location information are described with reference to FIG. 4.

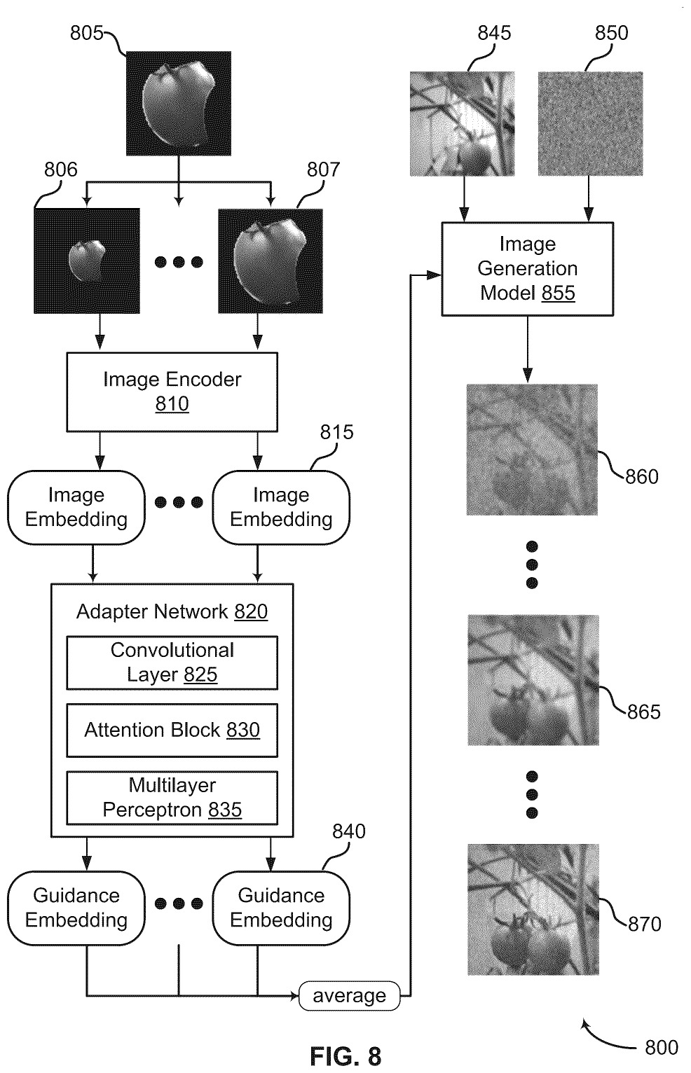

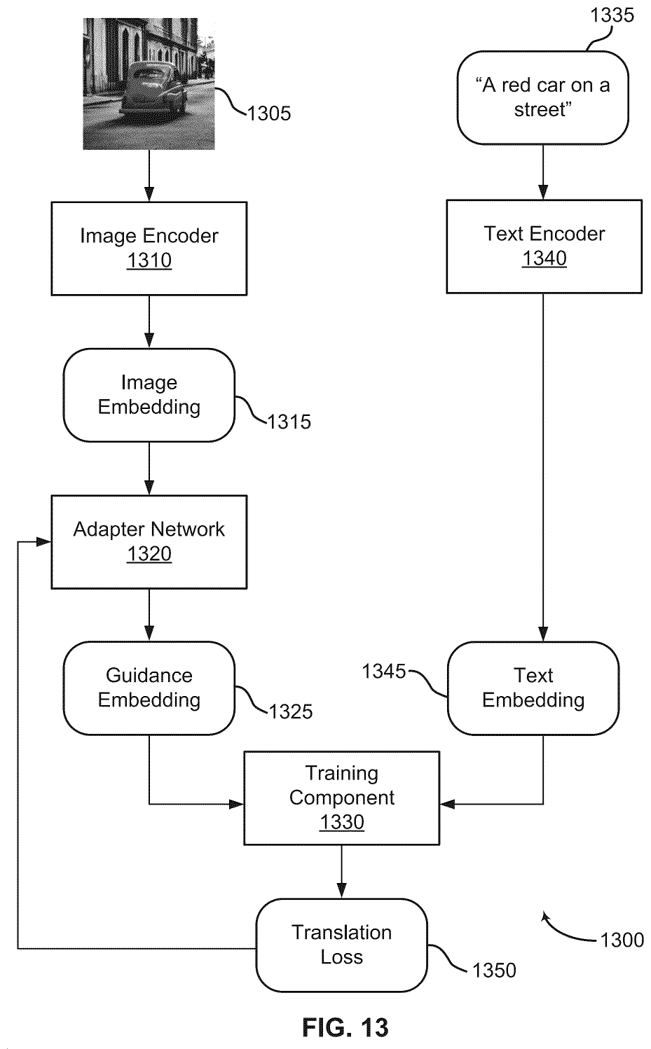

At operation 610, the system generates, using an adapter network, a guidance embedding based on the second image. In some cases, the operations of this step refer to, or may be performed by, an adapter network as described with reference to FIGS. 7, 8, and 13. In some cases, guidance embedding is an example of, or includes aspects of, the corresponding element described with reference to FIGS. 8 and 13. In some cases, the guidance embedding is in a text embedding domain transformed from the image embedding domain. In some cases, for example, the guidance embedding includes the same number of dimensions as a text embedding used to train the image generation model.

In some cases, for example, the image generation model encodes object information of the foreground image using a pretrained Vision Transformer (ViT) and a Content Adaptor. For example, the pretrained ViT receives an image (such as the foreground image) as input and outputs an image embedding. Then, a Content Adaptor is used to transform the image embedding into a guidance embedding. In some cases, the guidance embedding may include text embedding, which can be used as input to a text-to-image diffusion model.

At operation 615, the system generates, using an image generation model, a synthetic image depicting the foreground element and the background scene based on the first image and the guidance embedding, where the image generation model determines a location of the foreground element within the synthetic image in light of the background scene. In some examples, a foreground object could be placed within the scene consistent with affordances of objects in the scene. For example, a person could be walking on a road, or sitting in a chair, or a bird could be sitting on a pole or wire. In some cases, the operations of this step refer to, or may be performed by, an image generation model as described with reference to FIGS. 3-5, 7, and 8.

According to some embodiments, the machine learning model (including the image generation model) determines the location of the foreground element at a position of the synthetic image based on the relationship between the foreground element and the background scene. For example, the image generation model is trained using training data including a ground truth composite image, a synthetic foreground image, and a synthetic background image. By training the image generation model using the training data, the image generation model can learn the relationship between the foreground element and the background scene. For example, the location of the foreground element in the background scene of the synthetic image is determined by the foreground image and the background image. Accordingly, the image generation model can automatically generate a realistic synthetic image having diverse composition based on the input of a background image (e.g., the first image) and a foreground image (e.g., the second image).

Conventional image generation model requires a user to provide a bounding box or a mask defining the location of the foreground object to be placed in a background scene in addition to the foreground image and the background image. However, according to embodiments of the present disclosure, the input to the image generation model is a foreground image depicting a foreground element and a background image depicting a background scene. Accordingly, the foreground element can be composited to any region of the background scene of the synthetic image.

In some cases, for example, the image generation model receives a noise map as input, where the noise map has a same dimension (or resolution) as the background image. In some cases, the noise map is combined with the background image to generate a noisy image, where the noisy image is used as input to the image generation model. In some cases, the image generation model adds noise to all pixels of the background image. The image generation model performs a reverse diffusion process on the noisy image by iteratively removing noise to generate the synthetic image.

In some cases, the background image is concatenated to the foreground image in all timesteps during training. By concatenating the background image, the image generation model can generate a synthetic image that inherits the structure (or features or content) of the background image. In some cases, the content of the background image is preserved. In some cases, the diffusion process is extended to all pixels of the background image instead of a region of the background image. As a result, the image generation model can increase the flexibility and diversity of the synthetic image.

### System Architecture

In FIGS. 7-9, an apparatus, system, and method for image processing are described. One or more aspects of the apparatus, system, and method include at least one processor and at least one memory storing instructions executable by the at least one processor. Embodiments further include an image encoder comprising parameters stored in the at least one memory and trained to encode a foreground image to obtain an image embedding. Embodiments further include an adapter network comprising parameters stored in the at least one memory and trained to generate a guidance embedding based on the image embedding. Embodiments further include an image generation model comprising parameters stored in the at least one memory and trained to generate a synthetic image based on a background image and the guidance embedding. In some cases, the synthetic image depicts a foreground element from the foreground image and at least a portion of a background scene from the background image.

Some examples of the apparatus, system, and method further include an object detection component comprising parameters stored in the at least one memory and trained to identifying the foreground element from an image. Some examples of the apparatus, system, and method further include a segmentation component comprising parameters stored in the at least one memory and trained to perform object segmentation on an image to generate a segmentation mask. Some examples of the apparatus, system, and method further include an inpainting component comprising parameters stored in the at least one memory and trained to generate the background image based on the segmentation mask.

FIG. 7 shows an example of an image processing apparatus 700 according to aspects of the present disclosure. The example shown includes image processing apparatus 700, processor unit 705, I/O module 710, memory unit 715, and training component 750. In one aspect, memory unit 715 includes image encoder 720, adapter network 725, image generation model 730, object detection component 735, segmentation component 740, and inpainting component 745. In one aspect, image processing apparatus 700 includes a machine learning model. Image processing apparatus 700 is an example of, or includes aspects of, the corresponding element described with reference to FIGS. 1, 8, and 13.

According to some embodiments of the present disclosure, image processing apparatus 700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, image processing apparatus 700 includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

Processor unit 705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special-purpose components for modem processing, baseband processing, digital signal processing, or transmission processing. Processor unit 705 is an example of, or includes aspects of, the processor described with reference to FIG. 15.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna.

Examples of memory unit 715 include random access memory (RAM), read-only memory (ROM), or a hard disk. Examples of memory unit 715 include solid-state memory and a hard disk drive. In some examples, memory unit 715 is used to store computer-readable, computer-executable software including instructions that, when executed, cause a processor to perform various functions described herein. In some cases, memory unit 715 contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 715 store information in the form of a logical state. Memory unit 715 is an example of, or includes aspects of, the memory subsystem described with reference to FIG. 15.

In one aspect, memory unit 715 includes instructions executable by processor unit 705. In one aspect, memory unit 715 includes a machine learning model or stores parameters of a machine learning model. In one aspect, memory unit 715 includes image encoder 720, adapter network 725, image generation model 730, object detection component 735, segmentation component 740, and inpainting component 745.

In one aspect, a machine learning model includes image encoder 720, adapter network 725, image generation model 730, object detection component 735, segmentation component 740, and inpainting component 745. In some cases, the machine learning model is a computational algorithm, model, or system designed to recognize patterns, make predictions, or perform a specific task (for example, image processing) without being explicitly programmed.

According to some aspects, image encoder 720 encodes the second image to obtain an image embedding. In some cases, the guidance embedding is generated based on the image embedding. According to some aspects, image encoder 720 comprises parameters stored in the at least one memory and trained to encode a foreground image to obtain an image embedding. Image encoder 720 is an example of, or includes aspects of, the corresponding element described with reference to FIGS. 8, 9, and 13.

According to some aspects, adapter network 725 generates a guidance embedding based on the second image. According to some aspects, adapter network 725 generates a guidance embedding based on the training foreground image. According to some aspects, adapter network 725 comprises parameters stored in the at least one memory and trained to generate a guidance embedding based on the image embedding. Adapter network 725 is an example of, or includes aspects of, the corresponding element described with reference to FIGS. 8 and 13.

According to some aspects, image generation model 730 obtains a first image depicting a background scene and a second image depicting a foreground element. In some examples, image generation model 730 generates a synthetic image based on the first image and the guidance embedding. In some cases, the synthetic image depicts the foreground element from the second image and at least a portion of the background scene. In some examples, image generation model 730 combines the first image with a noise map to obtain a noisy image. In some cases, the image generation model 730 takes the noisy image as input. In some aspects, the noise map has a same resolution as the first image.

In some examples, image generation model 730 performs a reverse diffusion process. In some examples, image generation model 730 obtains location information for the foreground element of the second image. In some cases, a location of the foreground element in the synthetic image is determined based on the location information. In some aspects, a size of the foreground element is determined by the location information. In some examples, image generation model 730 obtains an additional image depicting an additional foreground element, where the synthetic image is generated to depict the additional foreground element.

According to some aspects, image generation model 730 generates a predicted image based on the training background image and the guidance embedding. According to some aspects, image generation model 730 comprises parameters stored in the at least one memory and trained to generate a synthetic image based on a background image and the guidance embedding. In some cases, the synthetic image depicts a foreground element from the foreground image and at least a portion of a background scene from the background image. In some aspects, the image generation model 730 is trained to combine multiple images using training data that includes a foreground image, a background image, and a ground truth image that combines the foreground image and the background image. Image generation model 730 is an example of, or includes aspects of, the corresponding element described with reference to FIGS. 3-5, and 8.

According to some aspects, object detection component 735 identifies a region of the ground truth image depicting the foreground element. According to some aspects, object detection component 735 comprises parameters stored in the at least one memory and trained to identifying the foreground element from an image. In some cases, object detection component 735 includes an object detection model. For example, the object detection model performs image segmentation on a region of an image to classify each pixel of the image into a class. In some cases, for example, the foreground element is identified using the classified information. In some embodiments, object detection component 735 is part of segmentation component 740.

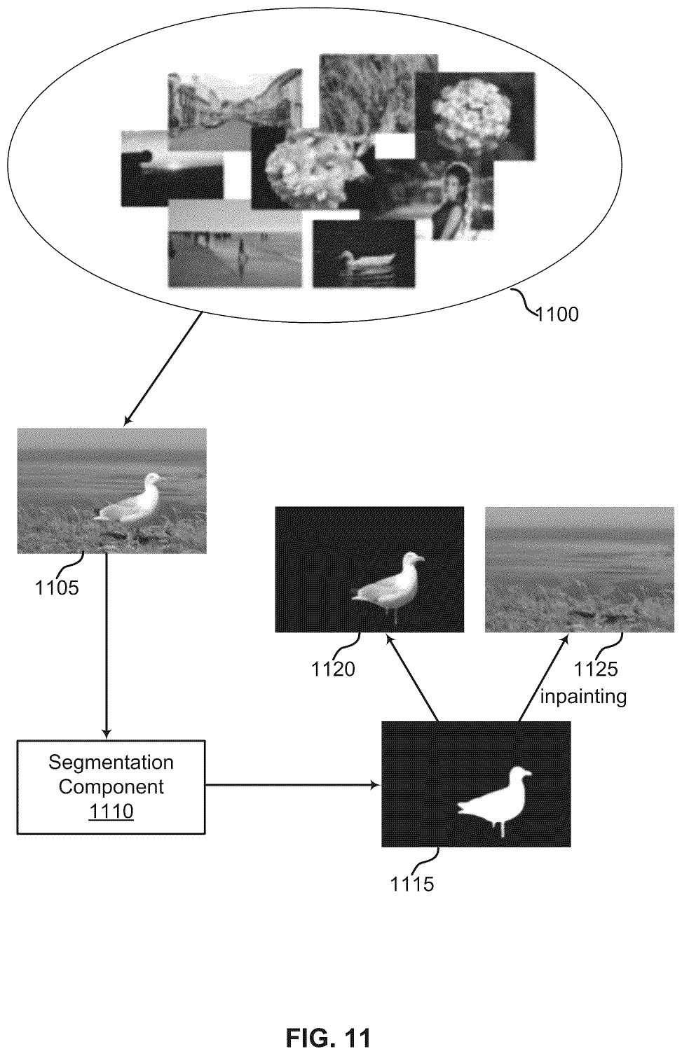

According to some aspects, segmentation component 740 performs object segmentation on the ground truth image to obtain a segmentation mask, where the training foreground image and the training background image are based on the segmentation mask. According to some aspects, segmentation component 740 comprises parameters stored in the at least one memory and trained to perform object segmentation on an image to generate a segmentation mask. Segmentation component 740 is an example of, or includes aspects of, the corresponding element described with reference to FIG. 11.

According to some embodiments, segmentation component 740 includes an image segmentation model. For example, the image segmentation model is EntitySeg. In some cases, the image segmentation model performs object segmentation on images to obtain class labels for each of the segmented objects in the images.

According to some aspects, inpainting component 745 generates an inpainting mask based on the segmentation mask. In some cases, the inpainting mask is different than the segmentation mask and the training background image is based on the inpainting mask. In some examples, inpainting component 745 performs inpainting based on the inpainting mask to obtain an inpainted image. In some examples, the training background image is based on the inpainted image. In some examples, inpainting component 745 refines the inpainted image to obtain the training background image. In some aspects, the inpainting mask includes a shadow region or a reflection region absent from the segmentation mask. According to some aspects, inpainting component 745 comprises parameters stored in the at least one memory and trained to generate the background image based on the segmentation mask.

According to some embodiments, inpainting component 745 includes a GAN-based inpainting model, for example, CM-GAN. In some cases, GAN refers to generative adversarial network. In some cases, inpainting component 745 includes a diffusion-based inpainting model, for example, CLIO-MD. The diffusion model is an example of, or includes aspects of, the corresponding element described with reference to FIG.

A GAN is an ANN in which two neural networks (e.g., a generator and a discriminator) are trained based on a contest with each other. For example, the generator learns to generate a candidate by mapping information from a latent space to a data distribution of interest, while the discriminator distinguishes the candidate produced by the generator from a true data distribution of the data distribution of interest. The generator's training objective is to increase an error rate of the discriminator by producing novel candidates that the discriminator classifies as “real” (e.g., belonging to the true data distribution).

Therefore, given a training set, the GAN learns to generate new data with similar properties as the training set. For example, a GAN trained on photographs can generate new images that look authentic to a human observer. GANs may be used in conjunction with supervised learning, semi-supervised learning, unsupervised learning, and reinforcement learning.

According to some aspects, training component 750 obtains training data including a training foreground image, a training background image, and a ground truth image that combines the training foreground image and the training background image. In some examples, training component 750 trains, using the training data, an image generation model 730 to generate a synthetic image based on an input foreground image and an input background image, where the synthetic image includes a foreground element from the input foreground image and a background region from the input background image. In some examples, training component 750 computes a loss function based on the predicted image and the ground truth image. In some examples, training component 750 updates parameters of the adapter network 725 based on the loss function. Training component 750 is an example of, or includes aspects of, the corresponding element described with reference to FIG. 13.

FIG. 8 shows an example of data flow in an image processing apparatus 800 according to aspects of the present disclosure. The example shown includes image processing apparatus 800, foreground image 805, first scaled foreground image 806, second scaled foreground image 807, image encoder 810, image embedding 815, adapter network 820, guidance embedding 840, background image 845, noise map 850, image generation model 855, first intermediate image 860, second intermediate image 865, and synthetic image 870. In one aspect, adapter network 820 includes convolutional layer 825, attention block 830, and multilayer perceptron 835.

Image compositing without an input of a bounding box or a mask involves the use of a machine learning model to accurately determine the location and scale of the foreground object of foreground image 805 to be combined into a background scene of background image 845. However, the machine learning model not only has to determine the relative size of the foreground object, but also extrapolate the apparent scale of the foreground object based on the geometry of background scene. For example, the size of a car is larger than the size of a person, however, if the car is positioned away in the background (e.g., away from a camera position), then the size of the car appears to be smaller in the image. In some cases, generating synthetic images based on training data to learn these parameters are insufficient.

In some cases, for example, when encoding a large foreground object, an encoder may emphasize on finer details of the foreground object. In some cases, when encoding a small foreground object, the encoder may prioritize structure-based high-level information. As a result, the performance of the encoder is inconsistent with respect to the size of the foreground object. Accordingly, embodiments of the present disclosure include a multi-scale object encoding.

Referring to FIG. 8, foreground image 805 and background image 845 are provided to image generation model 855 to generate synthetic image 870. In some embodiments, image processing apparatus 800 generates a plurality of scaled foreground images (e.g., first scaled foreground image 806 and second scaled foreground image 807). For example, a machine learning model performs resizing operation via bicubic down-sampling by a scale factor s using foreground image 805 to generate a plurality of scaled foreground images. In some cases, the scale factor s is represented as s∈{1, 0.75, 0.5, 0.25}. For example, first scaled foreground image 806 represents 0.25 times the foreground object. For example, second scaled foreground image 807 represents the full size of the foreground object.

In some cases, each of the resized foreground images (e.g., first scaled foreground image 806 and second scaled foreground image 807) is input into image encoder 810. In some cases, for example, image encoder 810 encodes first scaled foreground image 806 to obtain image embedding 815. In some cases, image encoder 810 encodes each of the plurality of scaled images to obtain a plurality of image embeddings. In some cases, image embedding 815 is input into adapter network 820 to generate guidance embedding 840. In some cases, adapter network 820 is implemented as a sequence-to-sequence translator architecture that transforms a sequence of visual tokens to a sequence of text tokens to overcome a domain gap between image and text.

For example, in some cases, convolutional layer 825 (such as a one-dimensional convolutional layer) modifies a length of image embedding 815 to a length of a text embedding which is used to train adapter network 820 (e.g., from 257 to 77). In some cases, attention block 830 bridges a gap between an image domain for image embedding 815 and a text domain for a text embedding by translating the length-modified image embedding to the text domain. In some cases, multilayer perceptron 835 modifies an embedding dimension of the translated embedding to an embedding dimension of a text embedding used to train the adapter network (e.g., from 1024 to 768).

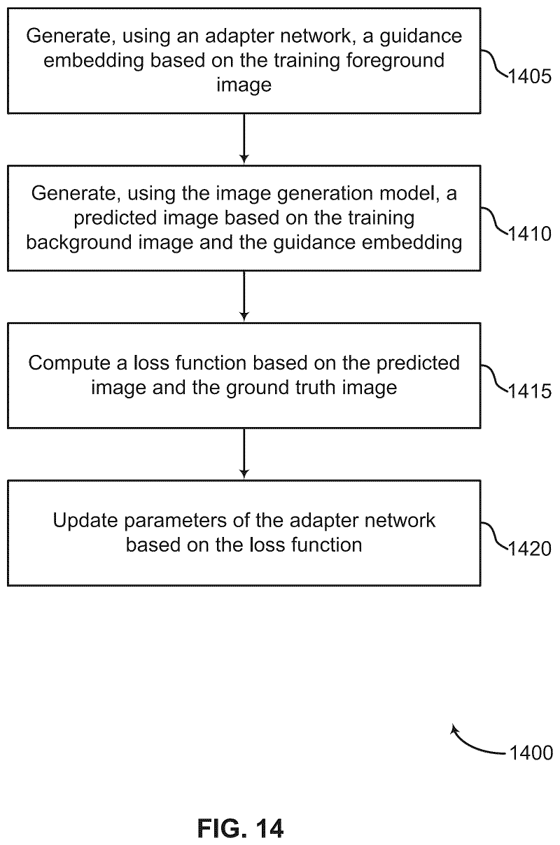

Accordingly, adapter network 820 translates and modifies image embedding 815 to obtain guidance embedding 840 in a text domain. In some cases, guidance embedding 840 captures fine-grained details of foreground image 805 provided by image embedding 815 that a text description of foreground image 805 could not. Additionally, performance and quality in the resulting output of the image generation model 855 are increased. In some embodiments, adapter network 820 is trained to obtain a guidance embedding 840 as described with reference to FIGS. 13-14.

In some embodiments, adapter network 820 generates a plurality of guidance embeddings based on the plurality of image embeddings, respectively. In some cases, for example, the machine learning model takes an average of the plurality of guidance embeddings and provide the averaged guidance embedding into image generation model 855. By averaging the plurality of guidance embeddings, image generation model 855 receives the foreground object with varying scales. Accordingly, image generation model 855 can accurately determine the scale of the foreground object within the composited image (e.g., synthetic image 870).

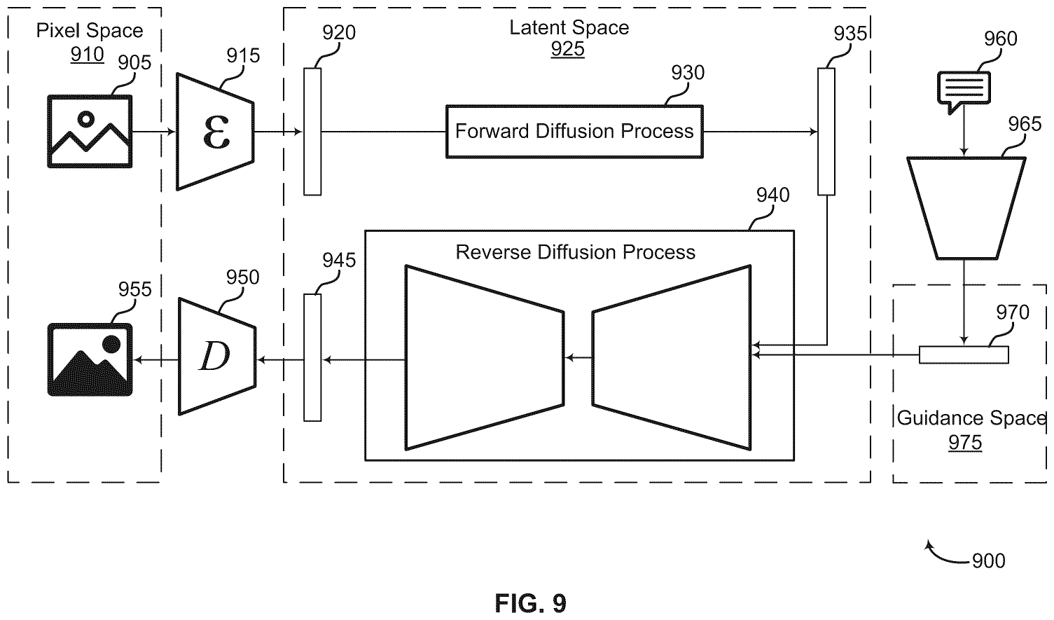

According to some aspects, image processing apparatus 800 adds noise map 850 (for example, using a forward diffusion process described with reference to FIG. 9) to all pixels of background image 845 to obtain a noisy image. In some cases, the image generation model 855 receives noise map 850 as one of the inputs along with guidance embedding 840 and background image 845. In some cases, noise map 850 has a resolution of the background image. For example, by combining the noise map 850 with background image 845, image generation model 855 can perform a reverse diffusion process on all pixels of background image 845. In some cases, the foreground element from foreground image 805 is not constrained within a region of background image 845 because the reverse diffusion process is performed on all pixels of background image 845.

In some cases, guidance embedding 840 is used to guide the reverse diffusion process of image generation model 855. For example, at each diffusion timestep, guidance embedding 840 is used to guide the diffusion process to obtain first intermediate image 860, where first intermediate image 860 is a noisy image including features of foreground image 805 and background image 845. Then, guidance embedding 840 is used to guide the diffusion process to obtain second intermediate image 865, where second intermediate image 865 is less noisy than first intermediate image 860.

In some cases, image generation model 855 receives guidance embedding 840, background image 845, and noise map 850 as input. In some cases, image generation model 855 gradually denoises all pixels of the noisy image in an iterative reverse diffusion process (such as the reverse diffusion process described with reference to FIG. 9). In some cases, to condition the reverse diffusion process on guidance embedding 840, image generation model 855 applies an attention mechanism as:

$$Softmax ( \frac{( {W}_{Q} {\hat{E}}_{x} ) {( {W}_{K} \hat{E} )}^{T}}{\sqrt{d}} ) {W}_{V} \hat{E} = AV \qquad ( 1 )$$

where Êₓ is an intermediate representation of a denoising autoencoder (for example, implemented using a diffusion model as described with reference to FIG. 9), Q, K, and V are query, key, and value representations, respectively, and W_{Q}∈ [symbol] ^{d×d}^{ₓ}, W_{K}∈ [symbol] ^{d×d}^{ₑ}, and W_{V}∈ [symbol] ^{d×d}^{ₓ} represent embedding matrices.

In some cases, at each step of the reverse diffusion process, image generation model 855 therefore outputs a partially denoised intermediate image (such as first intermediate image 860 and second intermediate image 865) until a final reverse diffusion step is performed and a fully denoised composite image is generated. In some cases, the fully denoised composite image is referred to as synthetic image 870. In some cases, synthetic image 870 is output by the reverse diffusion process as composite image features, and a decoder of image generation model 855 decodes the composite image features to obtain synthetic image 870.

Image processing apparatus 800 is an example of, or includes aspects of, the corresponding element described with reference to FIGS. 1, 7, and 13. Foreground image 805 is an example of, or includes aspects of, the corresponding element described with reference to FIGS. 3-5. Image encoder 810 is an example of, or includes aspects of, the corresponding element described with reference to FIGS. 7, 9, and 13.

Image embedding 815 is an example of, or includes aspects of, the corresponding element described with reference to FIG. 13. Adapter network 820 is an example of, or includes aspects of, the corresponding element described with reference to FIGS. 7 and 13. Guidance embedding 840 is an example of, or includes aspects of, the corresponding element described with reference to FIG. 13.

Background image 845 is an example of, or includes aspects of, the corresponding element described with reference to FIGS. 3-5. Image generation model 855 is an example of, or includes aspects of, the corresponding element described with reference to FIGS. 3-5, and 7. Synthetic image 870 is an example of, or includes aspects of, the corresponding element described with reference to FIGS. 3-5.

FIG. 9 shows an example of a diffusion model 900 according to aspects of the present disclosure. The example shown includes diffusion model 900, original image 905, pixel space 910, image encoder 915, original image feature 920, latent space 925, forward diffusion process 930, noisy feature 935, reverse diffusion process 940, denoised image feature 945, image decoder 950, output image 955, text prompt 960, text encoder 965, guidance feature 970, and guidance space 975.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 900 may take an original image 905 in a pixel space 910 as input and apply an image encoder 915 to convert original image 905 into original image features 920 in a latent space 925. Then, a forward diffusion process 930 gradually adds noise to the original image features 920 to obtain noisy features 935 (also in latent space 925) at various noise levels.

Next, a reverse diffusion process 940 (e.g., a U-Net ANN) gradually removes the noise from the noisy features 935 at the various noise levels to obtain the denoised image features 945 in latent space 925. In some examples, denoised image features 945 are compared to the original image features 920 at each of the various noise levels, and parameters of the reverse diffusion process 940 of the diffusion model are updated based on the comparison. Finally, an image decoder 950 decodes the denoised image features 945 to obtain an output image 955 in pixel space 910. In some cases, an output image 955 is created at each of the various noise levels. The output image 955 can be compared to the original image 905 to train the reverse diffusion process 940. In some cases, output image 955 refers to synthetic image (e.g., described with reference to FIGS. 3-5, and 8).

In some cases, image encoder 915 and image decoder 950 are pre-trained prior to training the reverse diffusion process 940. In some examples, image encoder 915 and image decoder 950 are trained jointly, or the image encoder 915 and image decoder 950 are fine-tuned jointly with the reverse diffusion process 940.

The reverse diffusion process 940 can also be guided based on a text prompt 960, or another guidance prompt, such as an image, a layout, a style, a color, a segmentation map, etc. The text prompt 960 can be encoded using a text encoder 965 (e.g., a multimodal encoder) to obtain guidance features 970 in guidance space 975. The guidance features 970 can be combined with the noisy features 935 at one or more layers of the reverse diffusion process 940 to ensure that the output image 955 includes content described by the text prompt 960. For example, guidance feature 970 can be combined with the noisy feature 935 using a cross-attention block within the reverse diffusion process 940. In some cases, text prompt 960 refers to the corresponding element described with reference to FIG. 13.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 960) describing content to be included in a generated image. For example, a user may provide the prompt “Space”. In some examples, guidance can be provided in a form other than text, such as via an image, a sketch, a color, a style, or a layout. The system converts text prompt 960 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A transformer, transformer model, or transformer network is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give every word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism is a method of placing differing levels of importance on different elements of an input. Calculating attention may involve three basic steps. First, a similarity between query and key vectors obtained from the input is computed to generate attention weights. Similarity functions used for this process can include dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

The term “self-attention” refers to a machine learning model in which representations of the input interact with each other to determine attention weights for the input. Self-attention can be distinguished from other attention models because the attention weights are determined at least in part by the input itself.

A noise map is initialized that includes random noise. The noise map may be in a pixel space or a latent space. By initializing an image with random noise, different variations of an image including the content described by the conditional guidance can be generated. Then, the diffusion model 900 generates an image based on the noise map and the conditional guidance vector.

A diffusion process can include both a forward diffusion process 930 for adding noise to an image (e.g., original image 905) or features (e.g., original image feature 920) in a latent space 925 and a reverse diffusion process 940 for denoising the images (or features) to obtain a denoised image (e.g., output image 955). The forward diffusion process 930 can be represented as q(xₜ|xₜ₋₁), and the reverse diffusion process 940 can be represented as p(xₜ₋₁|xₜ). In some cases, the forward diffusion process 930 is used during training to generate images with successively greater noise, and a neural network is trained to perform the reverse diffusion process 940 (e.g., to successively remove the noise).

In an example forward diffusion process 930 for a latent diffusion model (e.g., diffusion model 900), the diffusion model 900 maps an observed variable x₀ (either in a pixel space 910 or a latent space 925) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 940. During the reverse diffusion process 940, the diffusion model 900 begins with noisy data x_{T}, such as a noisy image and denoises the data to obtain the p(xₜ₋₁|xₜ). At each step t−1, the reverse diffusion process 940 takes xₜ, such as the first intermediate image, and t as input. Here, t represents a step in the sequence of transitions associated with different noise levels, The reverse diffusion process 940 outputs xₜ₋₁, such as the second intermediate image iteratively until x_{T} is reverted back to x₀, the original image 905. The reverse diffusion process 940 can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 2 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = I}^{T} {p}_{θ} ( {x}_{t - 1} \vert {x}_{t} ) , \qquad ( 3 )$$

where p(x_{T})=N(x_{T}; 0,I) is the pure noise distribution as the reverse diffusion process 940 takes the outcome of the forward diffusion process 930, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space 925 as input and a generated data \tilde{x} is mapped back into the pixel space 910 from the latent space 925 as output. In some examples, x₀ represents an original input image with low image quality, latent variables x₁, . . . , x_{T} represent noisy images, and \tilde{x} represents the generated image with high image quality.

A diffusion model 900 may be trained using both a forward diffusion process 930 and a reverse diffusion process 940. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 930 in N stages. In some cases, the forward diffusion process 930 is a fixed process where Gaussian noise is successively added to an image. In latent diffusion models, the Gaussian noise may be successively added to features (e.g., original image features 920) in a latent space 925.

At each stage n, starting with stage N, a reverse diffusion process 940 is used to predict the image or image features at stage n−1. For example, the reverse diffusion process 940 can predict the noise that was added by the forward diffusion process 930, and the predicted noise can be removed from the image to obtain the predicted image. In some cases, an original image 905 is predicted at each stage of the training process.

The training component (e.g., training component described with reference to FIG. 7) compares predicted image (or image features) at stage n−1 to an actual image (or image features), such as the image at stage n−1 or the original input image. For example, given observed data x, the diffusion model 900 may be trained to minimize the variational upper bound of the negative log-likelihood −log p_{θ}(x) of the training data. The training system then updates parameters of the diffusion model 900 based on the comparison. For example, parameters of a U-Net may be updated using gradient descent. Time-dependent parameters of the Gaussian transitions can also be learned.

Image encoder 915 is an example of, or includes aspects of, the corresponding element described with reference to FIGS. 7, 8, and 13. Text prompt 960 is an example of, or includes aspects of, the corresponding element described with reference to FIG. 13. Text encoder 965 is an example of, or includes aspects of, the corresponding element described with reference to FIG. 13.

### Training and Evaluation

In FIGS. 10-14, a method, apparatus, non-transitory computer readable medium, and system for image processing are described. One or more aspects of the method, apparatus, non-transitory computer readable medium, and system include obtaining training data including a training foreground image, a training background image, and a ground truth image that combines the training foreground image and the training background image. Embodiments further include training, using the training data, an image generation model to generate a synthetic image based on an input foreground image and an input background image. In some cases, the synthetic image includes a foreground element from the input foreground image and a background region from the input background image.

Some examples of the method, apparatus, non-transitory computer readable medium, and system further include identifying a region of the ground truth image depicting the foreground element. Some examples further include performing object segmentation on the ground truth image to obtain a segmentation mask, wherein the training foreground image and the training background image are based on the segmentation mask.

Some examples of the method, apparatus, non-transitory computer readable medium, and system further include generating an inpainting mask based on the segmentation mask, wherein the inpainting mask is different than the segmentation mask and the training background image is based on the inpainting mask. Some examples of the method, apparatus, non-transitory computer readable medium, and system further include performing inpainting based on the inpainting mask to obtain an inpainted image, wherein the training background image is based on the inpainted image.

Some examples of the method, apparatus, non-transitory computer readable medium, and system further include refining the inpainted image to obtain the training background image. In some aspects, the inpainting mask includes a shadow region or a reflection region absent from the segmentation mask.

Some examples of the method, apparatus, non-transitory computer readable medium, and system further include generating, using an adapter network, a guidance embedding based on the training foreground image. Some examples further include generating, using the image generation model, a predicted image based on the training background image and the guidance embedding. Some examples further include computing a loss function based on the predicted image and the ground truth image. Some examples further include updating parameters of the adapter network based on the loss function.

FIG. 10 shows an example of a method 1000 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to aspects of the present disclosure, the image generation model is trained over a million sets of images, where each set of images includes a training background image, a training foreground image (or objects), and a composite image that includes the foreground element from the training foreground image and the background scene from the training background image. In some cases, the training data can be used to complement existing image generation models or can be used for any further image composition tasks. In one embodiment, the training data is obtained by using different inpainting methods to generate the training background image.

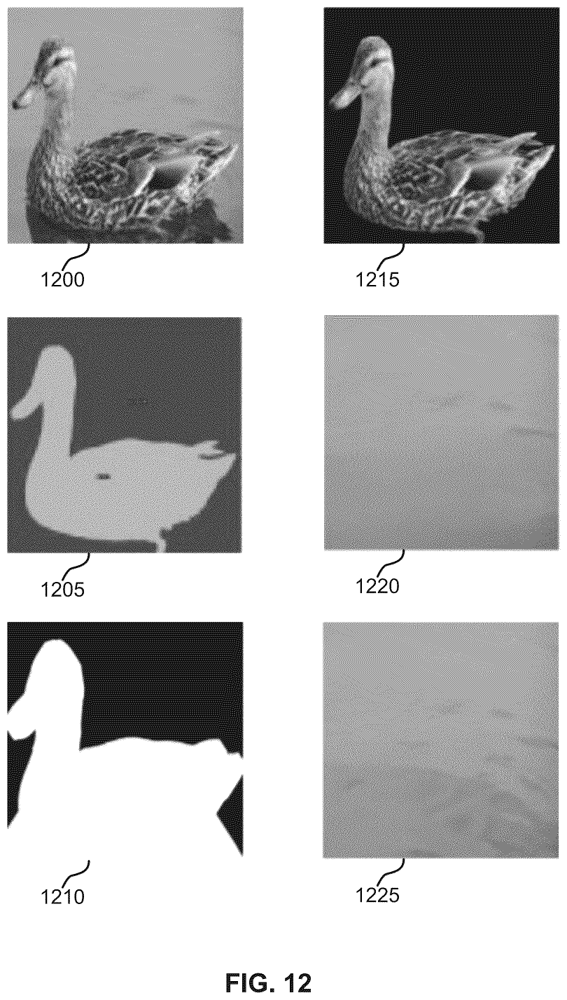

At operation 1005, the system obtains training data including a training foreground image, a training background image, and a ground truth image that combines the training foreground image and the training background image. In some cases, the operations of this step refer to, or may be performed by, a training component as described with reference to FIGS. 7 and 13. In some cases, the ground truth image is retrieved from a database (for example, the database described with reference to FIG. 1). In some cases, the ground truth image is retrieved from an external source (for example, from the Internet). In some cases, the training background image and the training foreground image are obtained by using a data preparation process described with reference to FIGS. 11 and 12.

At operation 1010, the system trains, using the training data, an image generation model to generate a synthetic image based on an input foreground image and an input background image, where the synthetic image includes a foreground element from the input foreground image and a background region from the input background image. In some cases, the operations of this step refer to, or may be performed by, a training component as described with reference to FIGS. 7 and 13. In some cases, for example, the input foreground image includes an element from the training foreground image. In some cases, for example, the input background image includes a portion of a scene from the training background image. In some cases, the synthetic image is compared to the ground truth image to compute a loss. In some cases, the loss is based on all pixels of the synthetic image. In some embodiments, the image generation model is trained and updated based on the loss.

Embodiments of the present disclosure include a multi-stage training. For example, the multi-stage training is used to train the machine learning model to learn accurate locations and scales of the foreground object without a mask input. In some embodiments, during the first training stage (represented as S1), image encoder (e.g., the image encoder described with reference to FIG. 8) is locked and the U-Net of the image generation model (e.g., the U-Net described with reference to FIG. 9) and adapter network (e.g., adapter network described with reference to FIGS. 7, 8, and 13) are trained jointly until convergence. However, the machine learning model, trained based on the first training stage, can generate synthetic images having increased diverse compositions but identity preservation of the foreground object may decrease. As used herein, a network or component is locked when the network or component is not trained.

In some embodiments, during a second training stage (represented as S2), the image encoder is finetuned on, for example, multi-view and video data. For example, the image encoder is trained on foreground object with different views and/or video frames of the foreground object. Then, image encoder is locked and the U-Net and adapter network are trained as described in S1. Accordingly, identity preservation of the foreground object increases. However, diversity of image composition may decrease.

In some embodiments, during the third training step (represented as S3), the machine learning model computes a weighted average of the weights from the first training stage and the second training stage. For example, the machine learning model may be represented as S3=0.25·S1+0.75·S2. Accordingly, the machine learning model at S3 generates results showing a satisfactory trade-off between the diversity of image composition and identity preservation. In some cases, the U-Net is finetuned based on the new weights.

In some embodiments, during a fourth training step (represented as S4), a perturbed ground-truth mask is used for 50% of the training to train the machine learning model. In some cases, the perturbed ground-truth mask approximates an intended location of foreground object in the synthetic image. For the remaining 50% of the training, the machine learning model is trained using an empty mask. In some cases, the values of the empty mask is set to −1. In some cases, the U-Net is finetuned. Accordingly, controllability on foreground object position of the machine learning model is increased.

In some cases, during training stages S1, S2, S3, and S4, the machine learning model is trained using a full scale (e.g., s=1) of foreground object. During a fifth training stage, the U-Net is trained using multi-scale information of the foreground object. For example, the U-Net is trained with foreground images with scale factor s. In some cases, s∈{1, 0.75, 0.5, 0.25}. Accordingly, scale accuracy of foreground objects in synthetic images is increased.

According to some embodiments, an output layer of the U-Net is trained while other networks and components (such as the image encoder, remaining layers of the U-Net, adapter network, and the image encoder-decoder pair of the diffusion model) are locked. Accordingly, the machine learning model can predict and generate a mask of the foreground object in synthetic image. In some cases, the machine learning model can generate additional effects, such as shadows and reflections, of the foreground object in synthetic image.

According to some embodiments, the image generation model is fine-tuned using the following loss functions:

$${ℒ}_{d} = {E}_{{I}_{c} , t , {a}_{o} , ϵ ∼ 𝒩 ( 0 , 1 )} [ {‖ ϵ - {ϵ}_{θ} ( {I}_{c} , t , {a}_{o} ) ‖}_{2}^{2} ] , \qquad ( 4 )$$

where aₒ= [symbol] , I_{c}=[Iₜ,Iₚ,I_{BG}], and ∈_{θ} represents the machine learning model being optimized. In some cases, Iₜ represents a noisy version of the input image I at timestep t. For example, input image I is the noisy image described with reference to FIG. 8. In some cases, for example, Iₜ represents the first intermediate image and second intermediate image described with reference to FIG. 8. In some cases, Iₚ represents a binary mask (e.g., the object mask described with reference to FIG. 5). In some cases, I_{BG} represents the background image.

In some embodiments, the dice loss [symbol] _{d} is used to estimate object mask Iₘ′(e.g., the object mask described with reference to FIG. 5) as an addition output of the image generation model.

$${L}_{m} = 1 - \frac{2 \cdot \vert {I}_{m} ⋂ {I}_{m}^{′} \vert}{\vert {I}_{m} \vert + \vert {I}_{m}^{′} \vert} , \qquad ( 5 )$$

where [⋅] represents concatenation operation across channel dimensions, and Iₘ represents the ground truth segmentation mask (e.g., the segmentation mask described with reference to FIGS. 11 and 12) for the foreground object in the training data. In some cases, [symbol] ₘ is integrated into the total loss by a scale factor of λ=0.01.

According to some embodiments, during training, the learning rate of the image encoder E is set to 10⁻⁴ and the learning rate of the U-Net is set to 4×10⁻⁵. In some cases, the multi-stage training is conducted on 8 A100 GPUs with, for example, Adam optimizer. In some cases, for example, the batch size is set to 1024. In some cases, for example, gradient accumulation is used.

FIG. 11 shows an example of generating training data according to aspects of the present disclosure. The example shown includes original dataset 1100, ground truth image 1105, segmentation component 1110, segmentation mask 1115, training foreground image 1120, and training background image 1125. In some cases, FIG. 11 refers to a data generation process.

Referring to FIG. 11, the image processing system obtains images from original dataset 1100. In some cases, for example, original dataset 1100 is obtained from Pixabay. For example, Pixabay comprises images having professional-level quality and good examples of creative compositions. In some cases, original dataset 1100 is obtained from other sources, for example, the Internet. In some cases, an image is retrieved from original dataset 1100 as ground truth image 1105. In some cases, ground truth image 1105 is stored in a database (for example, the database described with reference to FIG. 1).

In some cases, ground truth image 1105 is provided to a segmentation component 1110. In some cases, segmentation component 1110 is a segmentation model, for example, EntitySeg. In some cases, segmentation component 1110 performs image segmentation on ground truth image 1105 to obtain segmentation mask 1115. In some cases, segmentation component 1110 generates a class label for the segmented foreground object. In some cases, objects that are not part of the background scene are identified as foreground objects used for image composition. In some cases, segmentation component 1110 generates multiple segmentation masks based on the identified foreground objects.

In some cases, segmentation mask 1115 is used to obtain training foreground image 1120. In some cases, segmentation mask 1115 is used to obtain training background image 1125. For example, training background image 1125 is obtained by performing inpainting on segmentation mask 1115. Further details on obtaining training foreground image 1120 and training background image 1125 are described with reference to FIG. 12.

In some cases, ground truth image 1105, training foreground image 1120, and training background image 1125 are stored in a database (for example, the database described with reference to FIG. 1). In some cases, a million sets of images are stored as training dataset in the database. In some cases, each set of images include ground truth image 1105, training foreground image 1120, and training background image 1125. In an embodiment, the image generation model is trained using the training data. By training the image generation model with the training data, the image generation model can recognize and learn the relationships between foreground objects and a background scene. Accordingly, the image generation model can generate synthetic images that are more natural and cohesive.

Ground truth image 1105 is an example of, or includes aspects of, the corresponding element described with reference to FIG. 12. Segmentation component 1110 is an example of, or includes aspects of, the corresponding element described with reference to FIG. 7. Segmentation mask 1115 is an example of, or includes aspects of, the corresponding element described with reference to FIG. 12. Training foreground image 1120 is an example of, or includes aspects of, the corresponding element described with reference to FIG. 12.

FIG. 12 shows an example of generating a training foreground image and a training background image according to aspects of the present disclosure. The example shown includes ground truth image 1200, segmentation mask 1205, inpainting mask 1210, training foreground image 1215, first inpainted image 1220, and second inpainted image 1225. In some cases, FIG. 12 refers to a data preparation process.

Referring to FIG. 12, by using ground truth image 1200, the image generation system generates a segmentation mask 1205 that represents a region depicting the foreground object of ground truth image 1200. Segmentation mask 1205 is obtained by using a segmentation component (described with reference to FIG. 11). In some cases, training foreground image 1215 is obtained by using segmentation mask 1205. In some cases, the segmentation component performs image segmentation for each object in ground truth image 1200. For example, an object that is not part of the background scene is identified as a foreground object.

In some embodiments, a segmentation confidence score is applied to each foreground object. In one aspect, the segmentation confidence score is determined based on the number of pixels an object occupies in ground truth image 1200. Accordingly, the segmentation component can generate multiple segmentation masks based on ground truth image 1200. In some cases, each of the segmentation masks represents an object having a class label. In some embodiments, an object detection component (e.g., the object detection component described with reference to FIG. 7) is used to detect the foreground elements.

In some embodiments, a shadow detection component is used to detect shadows or reflections of the foreground element within ground truth image 1200. For example, a shadow detection component is an SSISv2 model. In some cases, a shadow having a low confidence score is discarded. In some cases, when an image (e.g., ground truth image 1200) includes a body of water, the shadow or reflection is determined by flipping the foreground object about an axis. In some cases, the shadow detection component generates a shadow mask. In some cases, the shadow mask includes a region depicting shadows, a region depicting reflections, or a combination thereof.

In some embodiments, segmentation mask 1205 and shadow mask are combined to generate inpainting mask 1210. For example, inpainting mask 1210 represents a region that depicts the foreground element and corresponding shadows (or reflections). The remaining region of inpainting mask 1210 represents a portion of the background scene. In some embodiments, an inpainting component (e.g., the inpainting component described with reference to FIG. 7) performs inpainting using ground truth image 1200 and inpainting mask 1210 to generate a training background image (for example, first inpainted image 1220 or second inpainted image 1225).

In some embodiments, the inpainting component performs a GAN-based inpainting process using ground truth image 1200 and inpainting mask 1210 to generate first inpainted image 1220. In some cases, the inpainting component performs the GAN-based inpainting process using CM-GAN. In some cases, first inpainted image 1220 depicts a simple background scene. To obtain a more realistic training background image, the inpainting component performs a second inpainting process to obtain a refined training background image.

In some cases, for example, the inpainting component performs a diffusion-based inpainting process (e.g., using CLIO-MD) using first inpainted image 1220 and inpainting mask 1210 to generate second inpainted image 1225. By performing the diffusion-based inpainting process, the inpainting component can generate a background image that is more realistic and has higher quality. For example, second inpainted image 1225 includes additional features or objects that enhance the quality of second inpainted image 1225. For example, second inpainted image 1225 includes additional ripples. In some cases, second inpainted image 1225 contains fewer artifacts and unnatural objects. In some cases, second inpainted image 1225 is used as the training background image.

In some embodiments, ground truth image 1200, training foreground image 1215, and second inpainted image 1225 (e.g., used as training background image) are used as training data to train the image generation model. In some cases, ground truth image 1200 corresponds to multiple training foreground images and training background images. In some cases, the training data is stored in a database.

Ground truth image 1200 is an example of, or includes aspects of, the corresponding element described with reference to FIG. 11. Segmentation mask 1205 is an example of, or includes aspects of, the corresponding element described with reference to FIG. 11. Training foreground image 1215 is an example of, or includes aspects of, the corresponding element described with reference to FIG. 11.

FIG. 13 shows an example of training an adapter network according to aspects of the present disclosure. The example shown includes image processing apparatus 1300, training image 1305, image encoder 1310, image embedding 1315, adapter network 1320, guidance embedding 1325, training component 1330, caption 1335, text encoder 1340, text embedding 1345, and loss 1350.

Referring to FIG. 13, in some cases, training component 1330 trains the adapter network 1320 based on loss 1350 (for example, translation loss), which is obtained based on a comparison of guidance embedding 1325 and text embedding 1345. The term “loss function” refers to a function that impacts how a machine learning model is trained in a supervised learning model. For example, during each training iteration, the output of the machine learning model is compared to the known annotation information in the training data. The loss function provides a value (a “loss”) for how close the predicted annotation data is to the actual annotation data. After computing the loss, the parameters of the machine learning model are updated accordingly and a new set of predictions are made for the next iteration.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (e.g., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

According to some aspects, training component 1330 provides training image 1305 to image encoder 1310, and image encoder 1310 encodes training image 1305 to obtain image embedding 1315. Adapter network 1320 generates guidance embedding 1325 based on image embedding 1315. In some cases, adapter network 1320 transforms image embedding 1315 from one embedding space to a different embedding space. In some cases, guidance embedding 1325 is in the same embedding space as text embedding 1345.

According to some aspects, training component 1330 provides caption 1335 describing training image 1305 to text encoder 1340. Text encoder 1340 encodes caption 1335 to obtain text embedding 1345 (e.g., a text embedding E∈ [symbol] ^{k×77×768})

According to some aspects, training component 1330 computes translation loss based on guidance embedding 1325 and text embedding 1345 according to a translation loss function:

$${ℒ}_{trans} = {‖ \hat{E} - E ‖}_{1} \qquad ( 6 )$$

According to some aspects, training component 1330 updates the adapter network parameters of adapter network 1320 based on loss 1350. According to some aspects, each of image encoder 1310 and text encoder 1340 are frozen while adapter network 1320 is trained. For example, adapter network 1320 is trained independently from image encoder 1310 and text encoder 1340.

Accordingly, in some cases, adapter network 1320 learns to generate a guidance embedding 1325 that includes characteristics of both the image embedding 1315 (such as high-level semantics) and text embedding 1345 (such as dimensions). In some cases, adapter network 1320 is fine-tuned.

Image processing apparatus 1300 is an example of, or includes aspects of, the corresponding element described with reference to FIGS. 1, 7, and 8. Image encoder 1310 is an example of, or includes aspects of, the corresponding element described with reference to FIGS. 7-9. Image embedding 1315 is an example of, or includes aspects of, the corresponding element described with reference to FIG. 8. Adapter network 1320 is an example of, or includes aspects of, the corresponding element described with reference to FIGS. 7 and 8.

Guidance embedding 1325 is an example of, or includes aspects of, the corresponding element described with reference to FIG. 8. Training component 1330 is an example of, or includes aspects of, the corresponding element described with reference to FIG. 7. Text encoder 1340 is an example of, or includes aspects of, the corresponding element described with reference to FIG. 9.

FIG. 14 shows an example of a method 1400 for training an adapter network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1405, the system generates, using an adapter network, a guidance embedding based on the training foreground image. In some cases, the operations of this step refer to, or may be performed by, an adapter network as described with reference to FIGS. 7, 8, and 13. Guidance embedding is an example of, or includes aspects of, the corresponding element described with reference to FIGS. 8 and 13.

At operation 1410, the system generates, using the image generation model, a predicted image based on the training background image and the guidance embedding. In some cases, the operations of this step refer to, or may be performed by, an image generation model as described with reference to FIGS. 3-5, 7, and 8. In some cases, the training background image is concatenated to the guidance embedding in all timesteps during training. By concatenating the background image, the image generation model can generate a synthetic image that inherits the structure (or features or content) of the background image. In some cases, the content of the background image is preserved.

At operation 1415, the system computes a loss function based on the predicted image and the ground truth image. In some cases, the operations of this step refer to, or may be performed by, a training component as described with reference to FIGS. 7 and 13. In some cases, the predicted image (or the synthetic image) is compared to the ground truth image to compute a loss. In some cases, the loss is based on all pixels of the predicted image. In some embodiments, the image generation model is trained and updated based on the loss.

At operation 1420, the system updates parameters of the adapter network based on the loss function. In some cases, the operations of this step refer to, or may be performed by, a training component as described with reference to FIGS. 7 and 13. In some cases, the adapter network is fine-tuned. In some cases, the adapter network generates an additional guidance embedding based on the update.

### Computing Device

FIG. 15 shows an example of a computing device 1500 according to aspects of the present disclosure. The example shown includes computing device 1500, processor(s) 1505, memory subsystem 1510, communication interface 1515, I/O interface 1520, user interface component(s), and channel 1530.

In some embodiments, computing device 1500 is an example of, or includes aspects of, the image processing apparatus described with reference to FIGS. 1, 7, 8, and 13. In some embodiments, computing device 1500 includes one or more processors 1505 that can execute instructions stored in memory subsystem 1510 to obtain a first image depicting a background scene and a second image depicting a foreground element. In some embodiments, the instructions further include to generate, using an adapter network, a guidance embedding based on the second image. In some embodiments, the instructions further include to generate, using an image generation model, a synthetic image based on the first image and the guidance embedding. In some cases, the synthetic image depicts the foreground element from the second image and at least a portion of the background scene.

According to some embodiments, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing. Processor(s) 1505 is an example of, or includes aspects of, the processor unit described with reference to FIG. 7.

According to some embodiments, memory subsystem 1510 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1510 is an example of, or includes aspects of, the memory unit described with reference to FIG. 7.

According to some embodiments, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1515.

According to some embodiments, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or hardware components controlled by the I/O controller.

According to some embodiments, user interface component(s) 1525 enables a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over existing technology (e.g., image generation models). Example experiments demonstrate that the image processing apparatus based on the present disclosure outperforms conventional image generation models. Details on the example use cases based on embodiments of the present disclosure are described with reference to FIGS. 3-5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a first image depicting a background scene and a second image depicting a foreground element;
generating, using an adapter network, a guidance embedding based on the second image; and
generating, using an image generation model, a synthetic image depicting the foreground element and the background scene based on the first image and the guidance embedding, wherein the image generation model determines a location of the foreground element within the synthetic image in light of the background scene.

2. The method of claim 1, wherein generating the guidance embedding comprises:
encoding, using an image encoder, the second image to obtain an image embedding, wherein the guidance embedding is generated based on the image embedding.

3. The method of claim 1, generating the synthetic image comprises:
combining the first image with a noise map to obtain a noisy image, wherein the image generation model takes the noisy image as input.

4. The method of claim 3, wherein:
the noise map having a same resolution as the first image.

5. The method of claim 1, generating the synthetic image comprises:
performing a reverse diffusion process.

6. The method of claim 1, further comprising:
obtaining location information for the foreground element of the second image, wherein a location of the foreground element in the synthetic image is determined based on the location information.

7. The method of claim 6, wherein:
a size of the foreground element is determined by the location information.

8. The method of claim 1, further comprising:
obtaining an additional image depicting an additional foreground element, wherein the synthetic image is generated to depict the additional foreground element.

9. The method of claim 1, wherein:
the image generation model is trained to combine multiple images using training data that includes a foreground image, a background image, and a ground truth image that combines the foreground image and the background image.

10. A method comprising:
obtaining training data including a training foreground image, a training background image, and a ground truth image that combines the training foreground image and the training background image; and
training, using the training data, an image generation model to generate a synthetic image based on an input foreground image and an input background image, wherein the synthetic image includes a foreground element from the input foreground image and a background region from the input background image.

11. The method of claim 10, wherein obtaining the training data comprises:
identifying a region of the ground truth image depicting the foreground element; and
performing object segmentation on the ground truth image to obtain a segmentation mask, wherein the training foreground image and the training background image are based on the segmentation mask.

12. The method of claim 11, further comprising:
generating an inpainting mask based on the segmentation mask, wherein the inpainting mask is different than the segmentation mask and the training background image is based on the inpainting mask.

13. The method of claim 12, further comprising:
performing inpainting based on the inpainting mask to obtain an inpainted image, wherein the training background image is based on the inpainted image.

14. The method of claim 13, further comprising:
refining the inpainted image to obtain the training background image.

15. The method of claim 12, wherein:
the inpainting mask includes a shadow region or a reflection region that is absent from the segmentation mask.

16. The method of claim 10, wherein the training the image generation model comprises:
generating, using an adapter network, a guidance embedding based on the training foreground image;
generating, using the image generation model, a predicted image based on the training background image and the guidance embedding;
computing a loss function based on the predicted image and the ground truth image; and
updating parameters of the adapter network based on the loss function.

17. An apparatus comprising:
at least one processor;
at least one memory storing instructions executable by the at least one processor;
an image encoder comprising parameters stored in the at least one memory and trained to encode a foreground image to obtain an image embedding;
an adapter network comprising parameters stored in the at least one memory and trained to generate a guidance embedding based on the image embedding; and
an image generation model comprising parameters stored in the at least one memory and trained to generate a synthetic image based on a background image and the guidance embedding, wherein the synthetic image depicts a foreground element and a first portion of the background scene, and wherein the foreground element is located at a position of the synthetic image that is determined by the image generation model.

18. The apparatus of claim 17, further comprising:
an object detection component comprising parameters stored in the at least one memory and trained to identifying the foreground element from an image.

19. The apparatus of claim 17, further comprising:
a segmentation component comprising parameters stored in the at least one memory and trained to perform object segmentation on an image to generate a segmentation mask.

20. The apparatus of claim 19, further comprising:
an inpainting component comprising parameters stored in the at least one memory and trained to generate the background image based on the segmentation mask.
